(19) United States
(12) Patent Application Publication
(10) Pub. No.: US 2002/0094308 A1
(43) Pub. Date: Jul. 18, 2002

(54) Process and apparatus for processing hydrogen sulfide from a gas

(76) Inventor: Bruce Dean Portz, Arvada, CO (US)

Correspondence Address: TransPotomac Plaza, Suite 306, 1033 N. Fairfax St., Alexandria, VA, 22314, US

(21) Appl. No.: 09/758,384

(22) Filed: Jan. 12, 2001

(51) Int. Cl. B01D 53/52; C01B 17/04; B01D 53/34

(52) U.S. Cl. 422/171; 423/573.1; 422/173; 422/177

(57) ABSTRACT

A process and apparatus for removing hydrogen sulfide and recovering elemental sulfur from a hydrogen sulfide containing gas particularly useful for removing hydrogen sulfide (H₂S) from tail gas. The process includes treating a hydrogen sulfide containing gas in a sulfur conversion unit to convert hydrogen sulfide to elemental sulfur, processing the tail gas from the sulfur-conversion unit via hydrolysis/hydrogenation to convert sulfur dioxide and other sulfur containing compounds to hydrogen sulfide, and passing the tail gas through a catalytic oxidation-reduction process to convert hydrogen sulfide gas to elemental sulfur.

### TECHNICAL FIELD AND INDUSTRIAL APPLICABILITY OF THE INVENTION

The present invention relates to a process and apparatus for removing hydrogen sulfide from gas. The process and apparatus are particularly useful for converting up to about 99.85% and above of feed H₂S to elemental sulfur. The present invention is also particularly useful for compliance with Federal environmental standards and air emission regulations set forth by the Environmental Protection Agency (EPA). Use of a process and/or an apparatus according to the present invention can provide a more efficient means to convert H₂S to elemental sulfur.

### BACKGROUND OF THE INVENTION

The present invention relates to treating gas, e.g. natural gas, to convert or remove impurities, such as hydrogen sulfide (H₂S). An absorption process often removes impurities. Absorption processes often use solvents, such as an aqueous amine solution, to aid in the removal of impurities. H₂S removed by one of these amine absorption processes is often fed to a Claus sulfur conversion unit (hereinafter Claus unit). A Claus unit is capable of converting approximately 93% to 97% of its feed H₂S into elemental sulfur (S°), depending on the feed concentration.

H₂S is a potential air pollutant and should be recovered in chemical, refining, or gas processing plants as elemental sulfur. The 93%-97% recovery of a typical stand alone Claus unit often will not meet state or Federal emission guidelines. Consequently, there has been an increasing need to supplement the performance of Claus units and reduce potential air pollutant emissions. There is also a need to increase overall conversion of H₂S to elemental sulfur.

There are a wide variety of processes for recovering H₂S that attempt to solve these problems. One such process is the Shell Claus Off-gas Treating (SCOT) processing arrangement as taught in Gas Purification, 3^{rd} Edition, 2^{nd} printing by Arthur Kohl and Fred Riesenfeld © 1979 at pages 683-686. The SCOT process is typically used throughout the industry to remove sulfur compounds from sulfur plant tail gas. The SCOT process is continuous and can provide overall H₂S conversion up to 99.7%. Tail gas from a Claus unit is usually fed to the SCOT processing plant. The SCOT process uses a hydrogenation/hydrolysis process to convert sulfur-bearing species to H₂S. The H₂S is then selectively removed in an amine absorption process and recycled back to the Claus unit inlet. Since the selective amine process is imperfect, some H₂S is lost to the incinerator and some carbon dioxide (CO₂) is recycled to the Claus unit. H₂S reaching the incinerator reduces overall conversion. Recycled CO₂ causes the Claus unit to increase in physical size while diluting the H₂S concentration and reducing the conversion potential.

A commercially available method for H₂S removal or recovery is the ARI LO-CAT II® (hereinafter LO-CAT) unit, available from United States Filter, Inc., Schaumburg, Ill. The LO-CAT process is generally described in U.S. Pat. No. 4,189,462, which is herein incorporated by reference in its entirety. The LO-CAT process is capable of converting 97% to 99% of its feed H₂S into elemental sulfur. The LO-CAT unit uses a regenerable aqueous iron chelate solution for conversion of H₂S to elemental sulfur. Sulfur exits the LO-CAT unit as a slurry with water. Gas exiting the LO-CAT unit is fed to an incinerator where any remaining H₂S is combusted to sulfur dioxide (SO₂) before being released to the air.

Tail gas from the Claus unit (hereinafter Claus tail gas) usually contains both H₂S and SO₂. Tail gas from the Claus unit is generally not fed directly to a LO-CAT unit due to the presence of SO₂. SO₂ is poisonous to LO-CAT chemicals. SO₂ irreversibly consumes constituent LO-CAT chemicals, which leads to excessive chemical consumption and operating costs. Additionally, Claus effluent, e.g., tail gas being fed directly from the Claus unit, is typically in the range of 300° F. The LO-CAT process typically operates at ambient temperatures between about 80° F. to about 120° F. Feeding Claus tail gas at about 300° F. directly to the LO-CAT unit leads to excessive chemical degradation and excessive make-up water use.

Due to increasingly stringent environmental demands there exists in the art a need for an efficient process and apparatus for treating natural gas and other gases for impurities such as CO₂ and H₂S. There is further a need to achieve higher conversion of H₂S to elemental sulfur. In addition, there is a need to maximize the applicability and efficiency of the LO-CAT process. One or more of these needs are met by the apparatus and process described below.

### SUMMARY OF THE INVENTION

In accordance with the present invention there is provided a process for converting hydrogen sulfide to elemental sulfur comprising: treating a hydrogen sulfide containing gas in a sulfur conversion unit to convert hydrogen sulfide to elemental sulfur, processing the tail gas from the sulfur conversion unit via hydrolysis/hydrogenation to convert sulfur dioxide and other sulfur containing compounds to hydrogen sulfide, and passing the tail gas through a catalytic oxidation-reduction process to convert hydrogen sulfide gas to elemental sulfur.

In accordance with another embodiment of the present invention there is provided an apparatus for converting hydrogen sulfide to elemental sulfur comprising: a first means for converting hydrogen sulfide to elemental sulfur, a hydrolysis/hydrogenation means in communication with said first means for converting sulfur dioxide and other sulfur containing compounds to hydrogen sulfide, and a second means in communication with said hydrolysis/hydrogenation means for converting hydrogen sulfide to elemental sulfur.

Further objects, features and advantages of the present invention will become apparent from the detailed description that follows.

### BRIEF DESCRIPTION OF THE DRAWINGS

The above and other aspects and advantages of the present invention will become apparent from the following detailed description of the preferred embodiments taken in conjunction with the drawing, wherein:

FIG. 1 is an exemplary schematic process flow diagram showing an H₂S-removal sulfur recovery process in accordance with the present invention.

FIG. 2 is an exemplary schematic process flow diagram of various conventional Claus units.

FIG. 3 is an exemplary schematic process flow diagram of a conventional LO-CAT unit.

### DETAILED DESCRIPTION OF THE PREFERRED EMBODIMENT

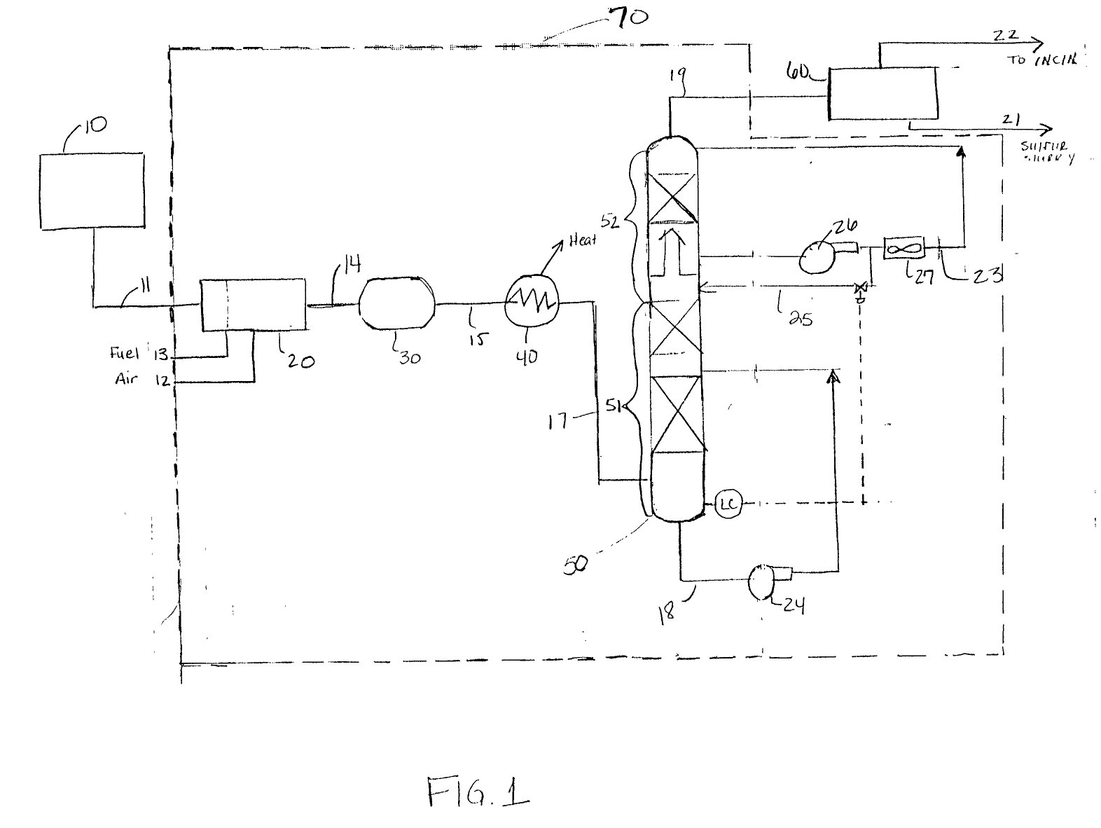

An overall process flow diagram in accordance with the present invention is shown in FIG. 1. H₂S is converted to elemental sulfur and water in a Claus sulfur conversion unit or other conversion unit, generally designated 10, according to the well-known Claus reaction:

H₂S+3/2O₂→H₂O+SO₂

and

SO₂+2H₂S→3S°+2H₂O

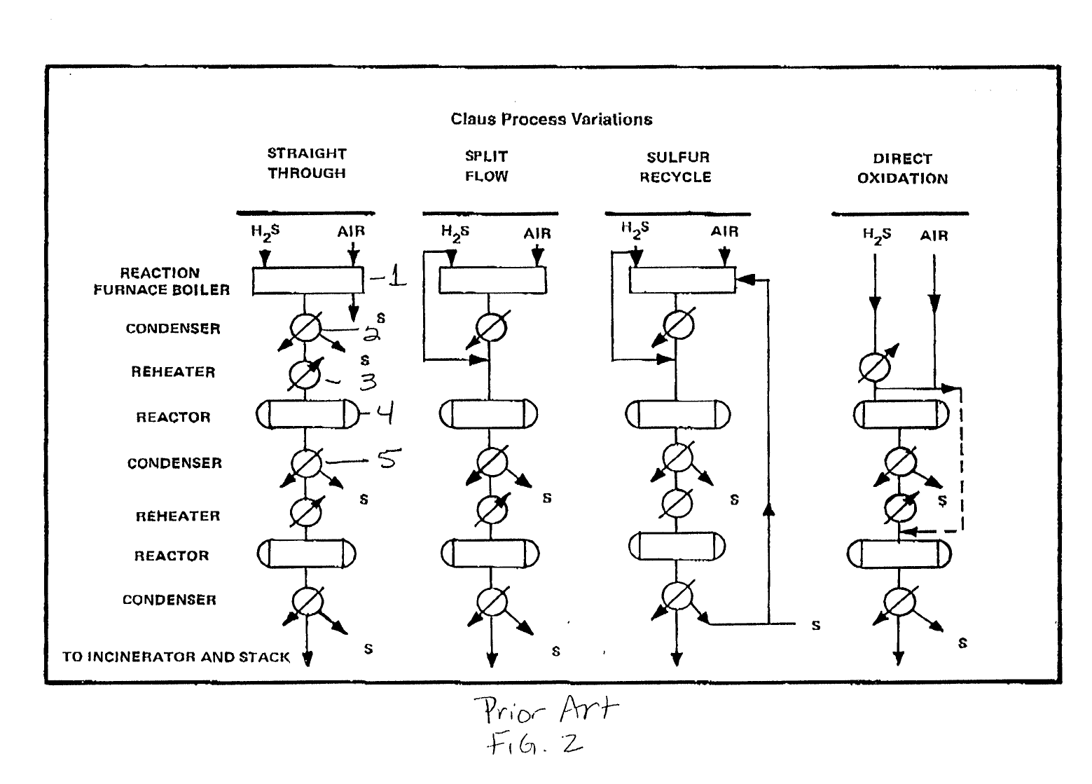

The removal of H₂S from feed gas is approximately between 93% and 97% due to various mechanical and equilibrium limitations. There are numerous variations and adaptations to a conventional Claus process as shown in FIG. 2. Any desired Claus unit or other unit to convert H₂S to S° can be used. In the straight through Claus process shown in FIG. 2, H₂S and air are introduced to a reaction furnace boiler 1. The reaction furnace boiler 1 comprises a muffle furnace (not shown), in which one third of the feed H₂S is converted to SO₂, and a reclaimer, preferably a waste heat boiler (not shown), that follows the furnace. The muffle furnace typically operates at temperatures in the range of about 1600° F. to about 2700° F. In the waste heat boiler, a utility heat stream is generated and the furnace effluent is cooled to about 600° F. The gas is then fed to a condenser 2 wherein the temperature of the gas is cooled to about 320° F. and elemental sulfur is condensed. The gas is then heated in a reheater 3 and fed to a catalytic reactor 4. Gas exiting the catalytic reactor 4 is fed to another condenser 5 wherein the temperature of the gas is reduced to about 320° F. and sulfur is condensed. The reheat, react, and cool process is typically repeated twice more for a total of three stages.

Tail gas from a Claus unit 10 fed via line 11, generally contains unconverted H₂S, SO₂, carboxyl sulfide (COS), carbon disulfide (CS₂), and S° vapor. The tail gas in line 11 is fed to a hydrolysis/hydrogenation processing section, generally shown as 70. The hydrolysis/hydrogenation processing section 70 aids in the conversion of SO₂, COS, CS₂ and S° vapor to H₂S. Unconverted SO₂, COS, CS₂, and S° vapor reacts with hydrogen (H₂) to form H₂S in the hydrolysis/hydrogenation processing section 70. There are several possible reactions that may occur in the hydrolysis/hydrogenation processing section 70. These reactions include:

Sₙ+nH₂→nH₂S

SO₂+3H₂→H₂S+2H₂O

COS+H₂O→H₂S+CO₂

CS₂+2H₂O→2H₂S+CO₂

The hydrolysis/hydrogenation section 70 may comprise, but is not limited to, a heating means for heating tail gas 20, catalytic reactor 30, waste heat boiler 40, and quench tower 50. Preferably, the heating means 20 is a heater, an inline heater, or a reducing gas generator. The catalytic reactor 30 is preferably a commercially available hydrolysis/hydrogenation unit. The hydrolysis/hydrogenation section converts sulfur and sulfur bearing species to H₂S and then cools the gas stream to a temperature suitable for feeding to LO-CAT unit 60.

The heating means 20 heats Claus tail gas, generally around 300° F., to between about 500° F. and about 700° F. as required by the processing parameters of catalytic reactor 30. The heating means 20 also provides hydrogen to the catalytic reactor 30. The temperature and hydrogen requirements of the catalytic reactor 30 can be provided by substoichiometric combustion of fuel gas. In this case, substoichiometric generally means combustion of fuel gas with about 5% to about 20% deficiency of air or oxygen. The fuel gas may be any light hydrocarbon stream, however methane is preferred. If an alternate hydrogen source is provided to the catalytic reactor 30, an inline heater may be used for providing only heat and not hydrogen to the catalytic reactor 30. A steam supply (not shown) may also be provided to the catalytic reactor 30 to improve temperature control and provide free water. Water helps support the reactions occurring in the catalytic reactor 30. Claus tail gas is preferably run at low pressures, sufficiently above atmospheric, so as to support flow through the catalytic reactor 30. Preferably, the pressure will be about 5 psig to about 10 psig.

Heated gases flow through the catalytic reactor 30, where sulfur compounds such as SO₂, CS₂, CO₂, and S° are converted to H₂S. Catalysts used in the catalytic reactor 30 are typically commercially available cobalt molybdenum based catalysts. The conversions take place due to the presence of hydrogen and to a lesser extent water. It is assumed that some water dissociates over the catalyst bed providing further hydrogen for the conversion reactions, which are exothermic and increase the temperature of the gas exiting the reactor by about 10° F. to 50° F. Gas exiting the reactor via line 15 is therefore generally about 510° F. to about 750° F.

The gas in line 15 is cooled by any desired method before it is fed to the LO-CAT unit 60 generally to about 80° F. to about 140° F. In a preferred embodiment of the present invention waste energy is recovered from the gas in line 15. As shown in FIG. 1, line 15 is fed to a waste heat boiler 40 to recover waste energy. The gas in line 15 is cooled using waste heat boiler 40. Generally enough energy is exerted by the waste heat boiler 40 to produce a utility heat stream such as steam or hot oil. Hot gas leaving the waste heat boiler 40 via line 17 is fed to a quench tower 50. The quench tower 50 uses recirculating water to cool the gas to near ambient temperatures, generally about 80° F. to 140° F.

The quench tower 50 provides for cooling the tail gas and the removal of small amounts of SO₂ present during process upsets or interruptions. The quench tower 50 is divided into two sections. A lower section 51 circulates a weak caustic solution, such as aqueous potassium hydroxide or sodium hydroxide, via line 18 through pump 24. The lower section 51 of quench tower 50 serves to remove heat and SO₂. Gas typically leaves the lower section 51 of the quench tower 50 at about 160° F. to about 180° F. Cooling in the lower section 51 is effected by the vaporization of part of the recirculating water stream via line 25. Recirculating water via line 23 further cools gas flowing to an upper section 52 of the quench tower 50. Recirculating water is circulated via pump 26 through an exchanger or quench cooler 27. Gas leaving the upper section 52 of quench tower 50 is generally about 80° F. to about 140° F. Claus tail gas exiting the quench tower 50 via line 19 is then fed to the LO-CAT unit 60, or other catalytic oxidation-reduction process for converting H₂S to S°.

Gas exiting the LO-CAT unit 60 via line 22 contains carbon dioxide, nitrogen, oxygen, water vapor and unreacted hydrogen sulfide. Sulfur exits the LO-CAT unit via line 21 as a slurry with water. Gas exiting the LO-CAT unit 60 via line 22 is fed to an incinerator where any remaining H₂S is combusted to SO₂, before being released to the air. Overall conversion of H₂S to S° using the processing arrangement according to the present invention is about 99.85%.

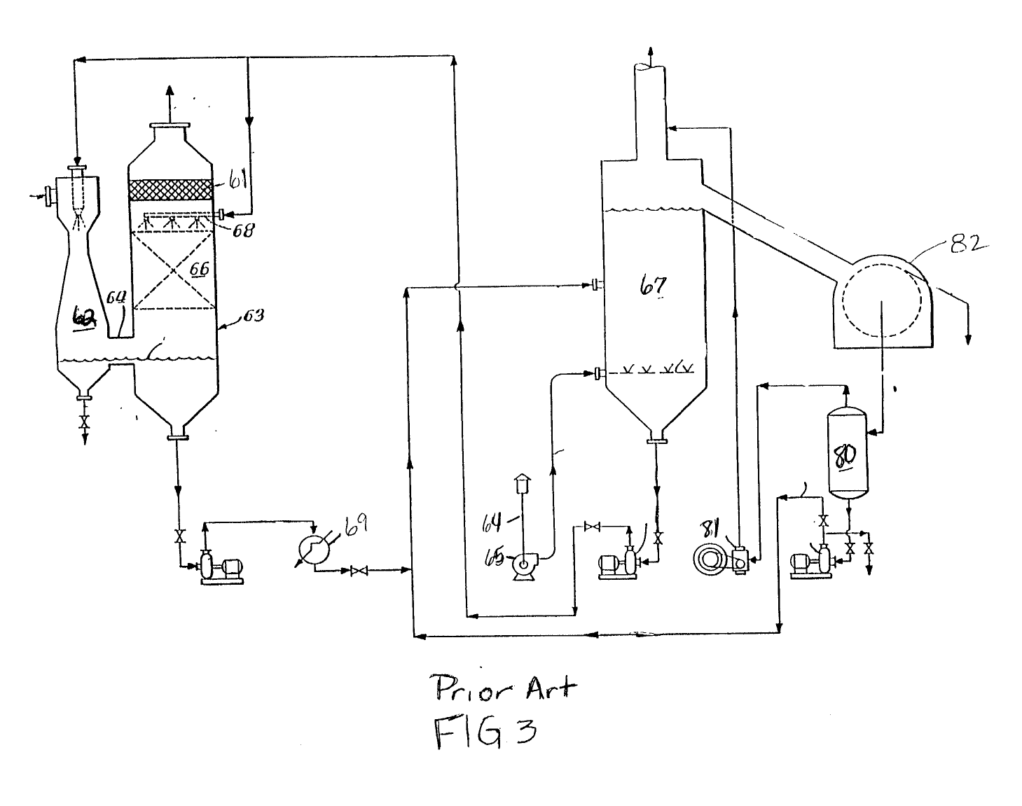

There are numerous variations of the LO-CAT process that can be used as 60. The present invention is not limited to the conventional LO-CAT unit discussed hereinafter. A typical conventional LO-CAT unit as disclosed in U.S. Pat. No. 4,189,462, is shown in FIG. 3. In general, the LO-CAT process is a catalytic oxidation-reduction process for removing hydrogen sulfide gas from a gaseous fluid stream by contacting the gaseous stream with an aqueous solution. The aqueous solution contains an iron chelate catalyst having iron in the ferric state adapted to oxidize the hydrogen sulfide to S° and be reduced to the ferrous state.

Gaseous hydrogen sulfide has a low solubility in an acidic aqueous solution. The catalytic oxidation of the hydrogen sulfide is preferably carried out in an aqueous alkaline solution, because hydrogen sulfide gas is absorbed more rapidly and sulfide ions are produced at a significantly increased rate when the reaction solution has a higher pH value. When the continuous catalytic oxidation-reduction reaction solution is maintained at the higher pH values and a conventional chelating agent used, an insoluble precipitate of ferric hydroxide is formed which removes iron from the reaction solution and reduces the concentration of catalytic reagent.

In a LO-CAT unit 60 adapted for the treatment of gas streams containing hydrocarbons or other oxygen-free gases, e.g. a sour natural gas, the removal of hydrogen sulfide and the regeneration of the chelated iron solution are carried out in separate reaction zones. The gas is introduced to a venturi scrubber 62 and a portion of the chelated iron solution is also introduced to the venturi scrubber 62. The lower portion of the scrubber 62 communicates with the lower portion of an absorption tower 63. The gas flows from the scrubber 62 and passes upwardly through a contact zone 66 in countercurrent relation with a downwardly flowing portion of the chelated iron solution supplied to nozzles 68 disposed above a contact zone 66. The treated gas exits from the top of the tower 63 after passing through a demister zone 61.

Chelated iron solution accumulates in the bottom portions of the scrubber 62 and the tower 63. A portion of the solution may be bled from the bottom of the scrubber 62 as desired. The solution accumulating in the bottom of the tower 63 is withdrawn and discharged into an oxidizer or regeneration vessel 67. If desired, a heat exchanger or cooler 69 may be interposed. In the vessel 67 the chelated iron solution is oxidized or regenerated by introduction of atmospheric air drawn through a screened inlet 64 by a blower 65 and supplied to nozzles located in the lower portion of the vessel 67. The air bubbles pass through and aerate the solution. The regenerated solution is continuously withdrawn from the bottom of the vessel 67 and is recirculated to the scrubber 62 and the tower 63.

The sulfur slurry is continuously withdrawn from the vessel 67 to a drum filter 82. Wet sulfur product is removed and filtrate is passed to a receiver 80. Vapor or gas is withdrawn from the receiver 80 by a vacuum pump 81 and is vented into the air. Filtrate is withdrawn from the bottom of the receiver 80 and is recirculated to the regeneration vessel 67. A portion of the filtrate may be bled from the system.

The present invention adds a hydrolysis/hydrogenation step prior to treating the tail gas in a LO-CAT unit 60. Adding the hydrolysis/hydrogenation step prior to LO-CAT processing provides several advantages. Tail gas from the Claus unit contains both H₂S and SO₂. Although the LO-CAT unit is an excellent process for removing H₂S, it does not adequately remove SO₂. Therefore, it is advantageous to remove SO₂ prior to treating the tail gas in the LO-CAT unit. In addition, LO-CAT chemicals react with SO₂. Thus by removing the SO₂ prior to LO-CAT processing, less LO-CAT chemical is consumed via reactions with SO₂.

Tail gas coming from the Claus unit is operating at about 300° F. In order to properly and efficiently operate the LO-CAT unit, the tail gas temperature should be about 80° F. to 140° F. At temperatures below 80° F., the LO-CAT unit generally does not work properly and at temperatures above 140° F., chemicals are often degraded. By adding a hydrolysis/hydrogenation step prior to LO-CAT processing, the tail gas temperature is cooled from, e.g. 300° F. to approximately about 120° F. to about 140° F. and preferably about 135° F. The LO-CAT unit can run at temperatures over 135° F. However by operating the LO-CAT unit with lower feed temperatures there is a reduction in make-up water requirements. High temperature streams being fed to and leaving the LO-CAT unit maintain high water vapor. High water vapor leaving the unit corresponds to an increase in the required amount of make-up water.

By adding a hydrolysis/hydrogenation step prior to treating the tail gas in a LO-CAT unit, the tail gas can be properly treated with one cycle. Thus it is not necessary to recycle the tail gas. By eliminating the recycle stream, the size of all involved equipment is reduced. Smaller equipment is less expensive for both purchasing and installation. Smaller systems also reduce utility requirements and operating costs.

The arrangement allows the LO-CAT process to be linked to the Claus process by eliminating the problems associated with high temperatures and the presence of SO₂. This arrangement allows very high overall conversion of H₂S. Unlike the SCOT process, a recirculating CO₂/H₂S stream does not increase the Claus unit sizing, since the arrangement of the present invention does not require a selective amine treater. Thus, the present invention improves the Claus unit operation. The arrangement of the present invention allows the Claus unit 10 to operate at a wide range of H₂S to SO₂ ratios. Claus tail gas is typically held to a 2 to 1 ratio. The processing arrangement of the present invention can be operated at H₂S to SO₂ ratios of from about 1:1 to about 10:2.

In the present invention, H₂S recovery specific to the Claus unit 10 is less critical due to the presence of the hydrolysis/hydrogenation unit and the LO-CAT unit 60. The preferred ratio of H₂S to SO₂ in Claus tail gas is 2:1. The presence of the hydrolysis/hydrogenation unit and the LO-CAT unit allow for the system to be more tolerant of upsets that cause the Claus tail gas H₂S to SO₂ ratio to deviate away from the preferred 2:1 ratio. This improves efficiency. The SCOT unit also has processing inefficiencies when the feed gas contains greater amounts of CO₂. The overall conversion of the processing arrangement of the present invention remains high for various feed gas qualities such as those with greater than 80% CO₂. The operating unit according to the present invention is about 99.9+% with a 20% quality Claus feed.

Various modifications of the above-described process of the invention will be apparent to those skilled in the art, and it is to be understood that such modifications can be made without departing from the scope of the invention.

We claim:

1. A process for converting hydrogen sulfide to elemental sulfur comprising:
treating a hydrogen sulfide containing gas in a sulfur conversion unit to convert hydrogen sulfide to elemental sulfur,
processing the tail gas from the sulfur conversion unit via hydrolysis/hydrogenation to convert sulfur dioxide and other sulfur containing compounds to hydrogen sulfide, and
passing the tail gas through a catalytic oxidation-reduction process to convert hydrogen sulfide gas to elemental sulfur.

2. A process as set forth in claim 1, wherein said sulfur conversion unit is a Claus sulfur conversion unit.

3. A process as set forth in claim 1, wherein overall conversion of removed hydrogen sulfide to elemental sulfur is about 99.85%.

4. A process as set forth in claim 1, wherein said catalytic oxidation-reduction process is a LO-CAT unit.

5. A process as set forth in claim 1, wherein said hydrolysis/hydrogenation comprises:
feeding tail gas from said sulfur conversion unit to a heating means to provide heated tail gas,
introducing hydrogen to said heating means,
passing said heated tail gas through a reactor, wherein sulfur dioxide and other sulfur containing compounds are converted to hydrogen sulfide, and
introducing said heated tail gas to a quench tower.

6. A process as set forth in claim 5, further comprising passing said heated tail gas through an exchanger for energy recovery prior to introducing said heated tail gas to said quench tower.

7. A process as set forth in claim 5, wherein said reactor is a catalytic reactor.

8. A process as set forth in claim 5, wherein said quench tower cools said heated tail gas to between about 80° F. to about 140° F.

9. An apparatus for converting hydrogen sulfide to elemental sulfur comprising:
a first means for converting hydrogen sulfide to elemental sulfur,
a hydrolysis/hydrogenation means in communication with said first means for converting sulfur dioxide and other sulfur containing compounds to hydrogen sulfide, and
a second means in communication with said hydrolysis/hydrogenation means for converting hydrogen sulfide to elemental sulfur.

10. An apparatus as set for the in claim 9, wherein said second means for converting hydrogen sulfide to elemental sulfur is a catalytic oxidation-reduction means.

11. An apparatus as set forth in claim 9, wherein said first means for converting hydrogen sulfide to elemental sulfur is a Claus sulfur conversion unit.

12. An apparatus as set forth in claim 9, wherein said catalytic oxidation-reduction means is a LO-CAT unit.

13. An apparatus as set forth in claim 9, wherein said hydrolysis/hydrogenation means comprises:
a reactor wherein sulfur containing compounds are converted to hydrogen sulfide, a heating means to provide heated tail gas and hydrogen to the reactor, and a quench tower for cooling said heated tail gas.

14. An apparatus as set forth in claim 13, further comprising an exchanger for receiving heated tail gas from said reactor, wherein said exchanger recovers energy prior to introducing said heated tail gas to said quench tower.
